(19) United States
(12) Patent Application Publication
(10) Pub. No.: US 2024/0203622 A1
(43) Pub. Date: Jun. 20, 2024

(54) NON-ORIENTED ELECTRICAL STEEL SHEET AND METHOD FOR MANUFACTURING SAME

(71) Applicant: POSCO Co., Ltd, Gyeongsangbuk-do (KR)

(72) Inventors: Hunju Lee, Pohang-si, Gyeongsangbuk-do (KR); Su-Yong Shin, Pohang-si, Gyeongsangbuk-do (KR); Yunsu Kim, Pohang-si, Gyeongsangbuk-do (KR)

(73) Assignee: POSCO Co., Ltd, Pohang-si, Gyeongsangbuk-do (KR)

(21) Appl. No.: 18/287,977

(22) PCT Filed: Dec. 20, 2022
(86) PCT No.: PCT/KR2022/020887

§ 371 Date: Oct. 23, 2023

(30) Foreign Application Priority Data
Dec. 22, 2021 (KR) 10-2021-0184549

(51) Int. Cl. H01F 1/147; C21D 1/74; C21D 6/00; C21D 8/12; C21D 9/46; C22C 38/00; C22C 38/02; C22C 38/04; C22C 38/06; C22C 38/12; C22C 38/14; C22C 38/60

(52) U.S. Cl. CPC H01F 1/14791; C21D 1/74; C21D 6/005; C21D 6/008; C21D 8/1222; C21D 8/1233; C21D 8/1261; C21D 9/46; C22C 38/001; C22C 38/002; C22C 38/004; C22C 38/008; C22C 38/02; C22C 38/04; C22C 38/06; C22C 38/12; C22C 38/14; C22C 38/60; C22C 2202/02

(57) ABSTRACT

A non-oriented electrical steel sheet according to an embodiment of the present invention may include, by wt %, 2.5 to 4.0% of Si, 0.1 to 1.5% of A1, 0.1 to 1.5% of Mn, and the remainder of Fe and inevitable impurities.

In the non-oriented electrical steel sheet according to an embodiment of the present invention, an average grain size is 50 to 100 μm, and an area ratio of grains having a grain size of 20 μm or less is 0.5% or more.

### TECHNICAL FIELD

An embodiment of the present invention relates to a non-oriented electrical steel sheet and a method for manufacturing the same. Specifically, an embodiment of the present invention relates to a non-oriented electrical steel sheet with improved magnetic properties and yield strength at low and high temperatures and a method for manufacturing the same, by adjusting the grain size distribution by controlling the residence time in a specific temperature range during twice hot-rolled sheet annealing and twice cold-rolled sheet annealing.

### BACKGROUND ART

A non-oriented electrical steel sheet is mainly used in motors that convert electrical energy into mechanical energy, and requires excellent magnetic properties of the non-oriented electrical steel sheet to exhibit high efficiency in this process. In particular, recently, as eco-friendly technology has attracted attention, it is considered that it is very important to increase the efficiency of motors, which account for the majority of the total electrical energy consumption, and to this end, the demand for a non-oriented electrical steel sheet having excellent magnetic properties is also increasing.

The magnetic properties of the non-oriented electrical steel sheet are mainly evaluated by iron loss and magnetic flux density. The iron loss means energy loss that occurs at specific magnetic flux density and frequency, and the magnetic flux density means the degree of magnetization obtained under a specific magnetic field. The lower the iron loss, the more energy-efficient motors may be manufactured under the same conditions, and since the higher the magnetic flux density, the smaller the motor or the lower the copper loss, a drive motor with excellent efficiency and torque can be manufactured by using a non-oriented electrical steel sheet with low iron loss and high magnetic flux density, thereby improving the mileage and output of eco-friendly vehicles.

The characteristics of the non-oriented electrical steel sheet to be considered according to an operating condition of the motor also vary. As a criterion for evaluating the characteristics of the non-oriented electrical steel sheet used in a motor, W15/50, which is iron loss when a 1.5 T magnetic field is applied at a commercial frequency of 50 Hz, has been widely used for a plurality of motors. However, for all motors for various uses, it is not considered that W15/50 iron loss is the most important, and depending on a main operating condition, iron loss at different frequencies or applied magnetic fields is evaluated according to a main operating condition. Particularly, in non-oriented electrical steel sheets used in recent electric vehicle drive motors, since magnetic properties are often important at low magnetic fields of 1.0 T or less and high frequencies of 400 Hz or more, the characteristics of the non-oriented electrical steel sheets are evaluated with iron loss such as W10/400.

The non-oriented electrical steel sheets for driving motors of eco-friendly vehicles require excellent strength as much as magnetic properties. The drive motors for the eco-friendly vehicles are mainly designed in the form of a permanent magnet inserted into a rotor, but in order for permanent magnet-inserted motors to exhibit excellent performance, the permanent magnets need to be located outside the rotor so as to be as close to the stator as possible. However, if the strength of the electrical steel sheet is low when the motor rotates at high speed, the permanent magnet inserted into the rotor may be separated by centrifugal force, and thus, an electrical steel sheet having high strength is required to secure the performance and durability of the motor. Particularly, considering the temperature rise due to motor operation, excellent strength at 170 to 250° C. is required.

A method commonly used to simultaneously increase the magnetic properties and strength of the non-oriented electrical steel sheet is to add an alloy element of Si, Al, Mn, or the like. If the resistivity of the steel is increased through the addition of these alloy elements, the eddy current loss may be reduced, thereby lowering the total iron loss. In addition, the alloy element is employed as a substitutional element to iron to cause a strengthening effect, thereby increasing the strength. On the other hand, as the added amount of alloy element such as Si, Al, and Mn increases, there is a disadvantage that the magnetic flux density deteriorates and brittleness increases, and when a certain amount or more is added, cold rolling becomes impossible, thereby making commercial production impossible. In particular, the thinner the thickness of the electrical steel sheet, the better the high-frequency iron loss, but the deterioration in rollability due to brittleness is a fatal problem.

Depending on the design intention of the motor, electrical steel sheets with improved strength may be used even though the magnetic properties are somewhat deteriorated, but as the method for manufacturing electrical steel sheets for this use includes a method of using precipitation of interstitial elements and a method of reducing the grain size. In order to increase the rotational speed by miniaturizing the motor or to increase the effect of the permanent magnet inserted into the rotor, a rotor made of an electrical steel sheet with significantly improved strength is used even though the magnetic properties of the electrical steel sheet are slightly deteriorated. In this case, when fine precipitates containing interstitial solid elements such as C, N, and S are formed, the effect of increasing the strength is good, but there is a disadvantage that the iron loss is rapidly deteriorated to rather reduce the efficiency of the motor. In addition, the method of reducing the grain size has a disadvantage in that the non-uniformity of the material of the steel sheet increases due to the addition of a non-recrystallization portion, thereby increasing the quality deviation of mass-produced products. In addition, most of previously proposed technologies for simultaneously improving magnetism and strength are not used for reasons such as increased manufacturing cost, decreased productivity and recovery, and lack of improvement effect.

### DISCLOSURE

### Technical Problem

The present invention attempts to provide a method for manufacturing a non-oriented electrical steel sheet. Specifically, an embodiment of the present invention provides a method for manufacturing a non-oriented electrical steel sheet with improved magnetic properties and yield strength at low and high temperatures, by adjusting the grain size distribution by controlling the residence time in a specific temperature range during twice hot-rolled sheet annealing and twice cold-rolled sheet annealing.

### Technical Solution

A non-oriented electrical steel sheet according to an embodiment of the present invention may include, by wt %, 2.5 to 4.0% of Si, 0.1 to 1.5% of Al, 0.1 to 1.5% of Mn, and the remainder of Fe and inevitable impurities.

In the non-oriented electrical steel sheet according to an embodiment of the present invention, an average grain size may be 50 to 100 μm, and an area ratio of grains having a grain size of 20 μm or less may be 0.5% or more.

The non-oriented electrical steel sheet according to an embodiment of the present invention may further include 0.006 to 0.1 wt % of at least one of Sn and Sb.

The non-oriented electrical steel sheet according to an embodiment of the present invention may further include 0.005 wt % or less of at least one of C, N, S, Ti, Nb and V.

The non-oriented electrical steel sheet according to an embodiment of the present invention may further include at least one of 0.05 wt % or less of P, 0.002 wt % or less of B, 0.01 wt % or less of Mo, 0.005 wt % or less of Mg, and 0.005 wt % or less of Zr.

In the non-oriented electrical steel sheet according to an embodiment of the present invention, yield strengths YS (−40° C.) and YS (210° C.) obtained when tensile tests are performed at −40° C. and 210° C. may satisfy YS (210° C.)/YS (−40° C.)≥0.71.

A method for manufacturing a non-oriented electrical steel sheet includes preparing a hot-rolled sheet by hot-rolling a slab comprising, by wt %, 2.5 to 4.0% of Si, 0.1 to 1.5% of Al, 0.1 to 1.5% of Mn, and the remainder of Fe and inevitable impurities; a first hot-rolled sheet annealing step of annealing the hot-rolled sheet at a temperature range of 950 to 1150° C. for 70 seconds or less; a second hot-rolled sheet annealing step of annealing the hot-rolled sheet at a temperature range of 900° C. or more and less than 950° C. for 15 seconds or more; preparing a cold-rolled sheet by cold-rolling the hot-rolled sheet; a first cold-rolled sheet annealing step of annealing the cold-rolled sheet at a temperature range of 900 to 1100° C. for 50 seconds or less; and a second cold-rolled sheet annealing step of annealing the cold-rolled sheet at a temperature range of 700 to 850° C. for 15 seconds or more.

The slab may further include 0.006 to 0.1 wt % of at least one of Sn and Sb.

The slab may further include 0.005 wt % or less of at least one of C, N, S, Ti, Nb, and V.

The slab may further include at least one of 0.05 wt % or less of P, 0.002 wt % or less of B, 0.01 wt % or less of Mo, 0.005 wt % or less of Mg, and 0.005 wt % or less of Zr.

The non-oriented electrical steel sheet according to an embodiment of the present invention may satisfy Equation 1 below.

$$\vert ( {T}_{HA 1} - {T}_{HA 2} ) \times ( {T}_{CA 1} - {T}_{CA 2} ) \vert \leq 1000 \qquad [ Equation 1 ]$$

(In Equation 1, T_{HA1} represents the residence time (sec) in the first hot-rolled sheet annealing step, T_{HA2} represents the residence time (sec) in the second hot-rolled sheet annealing step, T_{CA1} represents the residence time (sec) in the first cold-rolled sheet annealing step, and T_{CA2} represents the residence time (sec) in the second cold-rolled sheet annealing step.) The method may further include heating the slab at 1200° C. or lower before the preparing of the hot-rolled sheet.

The preparing of the hot-rolled sheet may include finish rolling at 800° C. or higher.

The first cold-rolled sheet annealing step and the second cold-rolled sheet annealing step may be performed under an atmosphere containing 40 volume % or less of hydrogen (H₂) and 60 volume % or more of nitrogen and having a dew point of 0 to −40° C.

After the second cold-rolled sheet annealing step, the average grain size may be 50 to 100 μm, and the area ratio of grains having a grain size of 20 μm or less may be 0.5% or more.

After the second cold-rolled sheet annealing step, the yield strengths YS (−40° C.) and YS (210° C.) obtained when the tensile test was performed at −40° C. and 210° C. may satisfy YS (210° C.)/YS (−40° C.)≥0.71.

### Advantageous Effects

According to an embodiment of the present invention, it is possible to manufacture a non-oriented electrical steel sheet with excellent iron loss and excellent yield strength at a motor operating temperature.

According to an embodiment of the present invention, it is possible to contribute to improving the performance of eco-friendly vehicle drive motors.

### MODE FOR INVENTION

Terms such as first, second and third are used to describe various parts, components, regions, layers and/or sections, but are not limited thereto. These terms are only used to distinguish one part, component, region, layer or section from another part, component, region, layer or section. Accordingly, a first part, component, region, layer or section to be described below may be referred to as a second part, component, region, layer or section without departing from the scope of the present invention.

The terms used herein is for the purpose of describing specific embodiments only and are not intended to be limiting of the present invention. The singular forms used herein include plural forms as well, if the phrases do not clearly have the opposite meaning. The “comprising” used in the specification means that a specific feature, region, integer, step, operation, element and/or component is embodied and other specific features, regions, integers, steps, operations, elements, components, and/or groups are not excluded.

When a part is referred to as being “above” or “on” the other part, the part may be directly above or on the other part or may be followed by another part therebetween. In contrast, when a part is referred to as being “directly on” the other part, there is no intervening part therebetween.

In addition, unless otherwise specified, % means wt %, and 1 ppm is 0.0001 wt %.

In an embodiment of the present invention, the meaning of further including an additional element means replacing and including iron (Fe), which is the remainder by an additional amount of an additional element.

Unless defined otherwise, all terms including technical and scientific terms used herein have the same meaning as commonly understood by those skilled in the art to which the present invention belongs. Commonly used predefined terms are further interpreted as having a meaning consistent with the relevant technical literature and the present invention and are not to be construed as ideal or very formal meanings unless defined otherwise.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

A non-oriented electrical steel sheet according to one embodiment of the present invention may include, by wt %, 2.5 to 4.0% of Si, 0.1 to 1.5% of Al, 0.1 to 1.5% of Mn, and the remainder of Fe and inevitable impurities.

Hereinafter, reasons for limiting the components of the non-oriented electrical steel sheet will be described.

### Si: 2.5 to 4.0 wt %

Silicon (Si) serves to increase the resistivity of the material, lower iron loss, and increase strength by solid solution hardening. If too little Si is added, an effect of improving iron loss and strength may be insufficient. When too much Si is added, brittleness of the material is increased so that rolling productivity is rapidly decreased, and an oxide layer and an oxide in the surface layer that are harmful to magnetic properties are formed. Accordingly, Si may be included in an amount of 2.5 to 4.0 wt %. More specifically, Si may be included in an amount of 2.6 to 3.8 wt %. More specifically, Si may be included in an amount of 2.7 to 3.7 wt %.

### Al: 0.1 to 1.5 wt %

Aluminum (Al) serves to increase the resistivity of the material, lower iron loss, and increase strength by solid solution hardening. If too little Al is added, it may be difficult to obtain a magnetic property improvement effect because fine nitrides are formed. If too much Al is added, nitrides are excessively formed to deteriorate magnetic properties and cause problems in all processes such as steelmaking and continuous casting, thereby greatly reducing productivity. Accordingly, Al may be included in an amount of 0.1 to 1.5 wt %. More specifically, Al may be included in an amount of 0.3 to 1.4 wt %.

### Mn: 0.1 to 1.5 wt %

Manganese (Mn) serves to increase the resistivity of the material to improve iron loss and form sulfides. If too little Mn is added, sulfide is formed finely to cause deterioration of magnetic properties, and if too much Mn is added, fine MnS is excessively precipitated and the formation of a {111} texture against magnetic properties is made, resulting in a rapid decrease in magnetic flux density. Accordingly, Mn may be included in an amount of 0.1 to 1.5 wt %. More specifically, Mn may be included in an amount of 0.2 to 1.3 wt %.

The non-oriented electrical steel sheet according to an embodiment of the present invention may further include 0.006 to 0.1 wt % of at least one of Sn and Sb.

### At Least One of Sn and Sb: 0.006 to 0.100 wt %

Tin (Sn) and antimony (Sb) serve to segregate on the grain boundary and the surface to delay the development of a {111} texture harmful to magnetic properties and suppresses the formation of an internal oxide layer in the early stage of recrystallization. If too little Sn and Sb are added, the aforementioned effect may not be sufficient. If too much Sn and Sb are added, surface defects may occur. Accordingly, at least one of Sn and Sb may be included in an amount of 0.006 to 0.100 wt %. More specifically, at least one of Sn and Sb may be included in an amount of 0.010 to 0.070 wt %. The at least one of Sn and Sb means the content of Sn or Sb alone when Sn or Sb is included alone, and the total amount of Sn and Sb when Sn and Sb are included simultaneously.

The non-oriented electrical steel sheet according to an embodiment of the present invention may further include 0.005 wt % or less of at least one of C, N, S, Ti, Nb and V.

### C: 0.0050 wt % or Less

Carbon (C) causes magnetic aging and is bound with other impurity elements to form carbides and improves the strength by deteriorating magnetic properties or interfering with potential shift. If too much C is added, fine carbide fractions may increase to deteriorate magnetic properties. Accordingly, C may be included in an amount of 0.0050 wt % or less. The lower limit of C is not particularly limited but may be included in an amount of 0.0010 wt % or more when considering productivity. That is, C may be included in an amount of 0.0010 to 0.0050 wt %.

### N: 0.0050 wt % or Less

Nitrogen (N) not only forms fine AlN precipitates inside a base material, but also forms fine precipitates in combination with other impurities to inhibit the grain growth, thereby deteriorating iron loss. Accordingly, N may be included in an amount of 0.0050 wt % or less. The lower limit of N is not particularly limited, but since N helps to improve the strength, the lower limit may be 0.0003 wt %. That is, N may be included in an amount of 0.0003 to 0.0050 wt %.

### S: 0.0050 wt % or Less

Sulfur (S) forms fine precipitates such as MnS and CuS to deteriorate magnetic properties and deteriorate hot workability. Accordingly, S may be included in an amount of 0.0050 wt % or less. The lower limit of S is not particularly limited, but since S helps to improve the magnetic flux density, the lower limit may be 0.0003 wt %. That is, S may be included in an amount of 0.0003 to 0.0050 wt %.

### Ti, Nb, V: Each 0.0050 wt % or Less

Titanium (Ti), niobium (Nb), and vanadium (V) have a very strong tendency to form precipitates in steel, and degrades iron loss by forming fine carbides, nitrides, or sulfides inside the base material to suppress grain growth and domain wall motion. Therefore, Ti, Nb, and V contents may each be 0.0050 wt % or less. The lower limit is not particularly limited but may be 0.0003 wt % due to steelmaking costs. That is, each of Ti, Nb and V may be included in an amount of 0.0003 to 0.0050 wt %.

The non-oriented electrical steel sheet according to an embodiment of the present invention may further include at least one of 0.05 wt % or less of P, 0.002 wt % or less of B, 0.01 wt % or less of Mo, 0.005 wt % or less of Mg, and 0.005 wt % or less of Zr.

### P: 0.050 wt % or Less

Phosphorus (P) serves to deteriorate hot-rolling characteristics and reduce productivity compared to improving magnetic properties. Accordingly, P may be included in an amount of 0.050 wt % or less. The lower limit is not particularly limited, but since P serves to segregate on the surface and grain boundaries of the steel sheet to suppress surface oxidation during annealing, hinder the diffusion of elements through grain boundaries, and hinder recrystallization of {111}/ND orientation, thereby improving the texture, the lower limit may be 0.005%. That is, P may be included in an amount of 0.005 to 0.050 wt %.

### B: 0.002 wt % or Less

When an excessive amount of boron (B) is added, magnetic properties may deteriorate through the formation of inclusions in the steel, and the like. Accordingly, B may be included in an amount of 0.002 wt % or less. The lower limit is not particularly limited but may be 0.0001 wt % due to steelmaking costs. That is, B may be included in an amount of 0.0001 to 0.0020 wt %.

### Mo: 0.01 wt % or Less

When too much Mo is added, the segregation of Sn and P may be suppressed, and the texture improvement effect may be reduced. Accordingly, Mo may be included in an amount of 0.01 wt % or less. The lower limit is not particularly limited but may include 0.001 wt % or more because Mo serves to improve the texture by segregating on the surface and grain boundaries. That is, Mo may be included in an amount of 0.001 to 0.010 wt %.

### Mg: 0.005 wt % or Less

Magnesium (Mg) is an element that mainly binds to S to form sulfides and may affect an oxide layer on the surface of base iron. Accordingly, Mg may be included in an amount of 0.005 wt % or less. The lower limit is not particularly limited, but may be 0.0001 wt % due to steelmaking costs. That is, Mg may be included in an amount of 0.0001 to 0.0050 wt %.

### Zr: 0.005 wt % or Less

When an excessive amount of zirconium (Zr) is added, magnetic properties may deteriorate through the formation of inclusions in the steel, and the like. Accordingly, Zr may be included in an amount of 0.005 wt % or less. The lower limit is not particularly limited, but may be 0.0001 wt % due to steelmaking costs. That is, Zr may be included in an amount of 0.0001 to 0.0050 wt %.

The remainder includes Fe and inevitable impurities. The inevitable impurities are impurities to be added during the steelmaking step and the manufacturing process of the oriented electrical steel sheet, and since the inevitable impurities are well known in the art, a detailed description thereof will be omitted. In an embodiment of the present invention, the addition of elements other than the above-described alloy components is not excluded, and may be variously included within a range without impairing the technical spirit of the present invention. Additional elements are further included by replacing the remainder Fe.

In the non-oriented electrical steel sheet according to an embodiment of the present invention, an average grain size may be 50 to 100 μm, and an area ratio of grains having a grain size of 20 μm or less may be 0.5% or more.

In an embodiment of the present invention, magnetic properties may be improved by securing the average grain size of 50 to 100 μm. In particular, high-frequency iron loss can be enhanced. In an embodiment of the present invention, the grain size means a diameter of a virtual circle when assuming the virtual circle having the same area as the grain area. The average grain size may be calculated as (measurement area÷number of grains)^{0.5}. The grain size can be measured based on a face parallel to a cross section (TD face) in a vertical direction of rolling. More specifically, the average grain size may be 60 to 95 μm.

In an embodiment of the present invention, the area ratio of grains having a grain size of 20 μm or less is 0.5% or more. By securing a large amount of fine grains having grain sizes, the strength may be improved, and in particular, yield strength at a high temperature may be improved.

In an embodiment of the present invention, the strength as well as magnetic properties may be secured simultaneously by simultaneously securing the average grain size and the fine grain area ratio.

In the non-oriented electrical steel sheet according to an embodiment of the present invention, yield strengths YS (−40° C.) and YS (210° C.) obtained when tensile tests are performed at −40° C. and 210° C. may satisfy YS (210° C.)/YS (−40° C.)≥0.710. More specifically, the values may be 0.710 to 0.730.

The yield strength YS (−40° C.) may be 450 to 550 MPa. The yield strength YS (210° C.) may be 325 to 400 MPa.

As such, by securing the yield strength at a specific temperature condition, when manufacturing a motor for driving an eco-friendly vehicle using the non-oriented electrical steel sheet according to an embodiment of the present invention, stable high-speed rotation is enabled in a wide temperature area to dramatically improve the efficiency of the motor.

Specifically, the iron loss W10/400 of the non-oriented electrical steel sheet may be 12.5 W/kg or less, and the magnetic flux density B₅₀ may be 1.650 T or more. The iron loss W10/400 is the iron loss when the magnetic flux density of 1.0 T is induced at a frequency of 400 HZ. The magnetic flux density B₅₀ is a magnetic flux density induced in a magnetic field of 5000 A/m. More specifically, the iron loss W10/400 of the non-oriented electrical steel sheet may be 10.0 to 12.0 W/kg or less, and the magnetic flux density B₅₀ may be 1.660 to 1.680 T.

A method for manufacturing the non-oriented electrical steel sheet according to an embodiment of the present invention includes preparing a hot-rolled sheet by hot-rolling a slab; a first hot-rolled sheet annealing step of the hot-rolled sheet; a second hot-rolled sheet annealing step of the hot-rolled sheet; preparing a cold-rolled sheet by cold-rolling the hot-rolled sheet; a first cold-rolled sheet annealing step of the cold-rolled sheet; and a second cold-rolled sheet annealing step of the cold-rolled sheet.

First, the slab is hot-rolled.

Since the alloy components of the slab have been described in the alloy components of the aforementioned non-oriented electrical steel sheet, duplicated descriptions will be omitted. Since the alloy components are not substantially changed during the manufacturing process of the non-oriented electrical steel sheet, the alloy components of the non-oriented electrical steel sheet and the slab are substantially the same as each other.

Specifically, the slab includes 2.5 to 4.0 wt % of Si, 0.1 to 1.5 wt % of Al, 0.1 to 1.5 wt % of Mn, and the remainder of Fe and inevitable impurities.

Since additional elements have been described in the alloy components of the aforementioned non-oriented electrical steel sheet, duplicated descriptions will be omitted.

The slab may be heated before hot rolling. The heating temperature of the slab is not limited, but the slab may be heated to 1200° C. or lower. If the heating temperature of the slab is too high, precipitates such as AlN and MnS present in the slab are re-dissolved and then finely precipitated during hot rolling and annealing to suppress the grain growth and reduce the magnetic properties.

Next, the hot-rolled sheet is prepared by hot-rolling the slab. The thickness of the hot-rolled sheet may be 2 to 2.3 mm. In the preparing of the hot-rolled sheet, a finish rolling temperature may be 800° C. or higher. Specifically, the finish rolling temperature may be 800° C. to 1000° C. The hot-rolled sheet may be wound at a temperature of 700° C. or lower.

After the preparing of the hot-rolled sheet, the first hot-rolled sheet annealing is performed. In this case, the hot-rolled sheet is annealed for 70 seconds or less at a temperature range of 950 to 1150° C. In the above-described temperature range, an optimal grain size is formed through recrystallization and grain growth of the hot-rolled sheet. Accordingly, by shortening the residence time in this temperature range, it is possible to appropriately control the grain size of the steel sheet and secure excellent strength and magnetic properties at the same time. More specifically, the hot-rolled sheet may be annealed at a temperature range of 950 to 1150° C. for 35 to 65 seconds.

In an embodiment of the present invention, the temperature at which the steel sheet is annealed refers to a temperature of the surface of the steel sheet.

Next, the hot-rolled sheet is subjected to second hot-rolled sheet annealing. In this case, the hot-rolled sheet is annealed for 15 seconds or more at a temperature range of 900° C. or higher and less than 950° C. In the first hot-rolled sheet annealing step, a microstructure having an appropriate grain size is formed, and in the second hot-rolled sheet annealing step, fine precipitates are grown, but in the above-described temperature range, nitrides, sulfides, etc. present in fine sizes in the hot-rolled sheet grow without being re-dissolved. Accordingly, by increasing the residence time in this temperature range, the fraction of fine precipitates of several tens of nm may be reduced. More specifically, the hot-rolled sheet may be annealed at a temperature range of 900° C. or higher and less than 950° C. for 20 to 60 seconds.

Next, the hot-rolled sheet is cold-rolled to prepare the cold-rolled sheet. The cold rolling is final rolling to a thickness of 0.1 mm to 0.35 mm. In the cold rolling step, the reduction ratio may be adjusted to 85% or more. More specifically, the reduction ratio may be 85 to 95%. If the reduction ratio is too low, a thickness difference in the width direction of the steel sheet may occur.

Next, the cold-rolled sheet is subjected to first cold-rolled sheet annealing. In this case, the cold-rolled sheet is annealed for 50 seconds or less at a temperature range of 900 to 1100° C. In the aforementioned temperature range, a microstructure having an optimal grain size is made through recrystallization and grain growth of the cold-rolled sheet. Accordingly, by shortening the residence time in this temperature range, it is possible to form a microstructure having excellent strength and magnetic properties at the same time. More specifically, the cold-rolled sheet may be annealed at a temperature range of 900 to 1100° C. for 30 to 50 seconds.

Next, the cold-rolled sheet is subjected to second cold-rolled sheet annealing. In this case, the cold-rolled sheet is annealed for 15 seconds or more at a temperature range of 700 to 850° C. In the second cold-rolled sheet annealing step, it is possible to coarsen fine precipitates that deteriorate magnetic properties while maintaining a microstructure having an appropriate grain size, and to reduce sheet internal stress generated during the cooling process of the steel sheet. Accordingly, by lengthening the residence time in this temperature range, iron loss may be improved while having the same microstructure. More specifically, the cold-rolled sheet may be annealed at a temperature range of 700 to 850° C. for 20 to 50 seconds.

The non-oriented electrical steel sheet according to an embodiment of the present invention may satisfy Equation 1 below.

$$\vert ( {T}_{HA 1} - {T}_{HA 2} ) \times ( {T}_{CA 1} - {T}_{CA 2} ) \vert \leq 1000 \qquad [ Equation 1 ]$$

(In Equation 1, T_{HA1} represents the residence time (sec) in the first hot-rolled sheet annealing step, T_{HA2} represents the residence time (sec) in the second hot-rolled sheet annealing step, T_{CA1} represents the residence time (sec) in the first cold-rolled sheet annealing step, and T_{CA2} represents the residence time (sec) in the second cold-rolled sheet annealing step.) When the residence time of each annealing step is adjusted to satisfy Equation 1, an appropriate average grain size and a fine grain fraction can be secured, which leads to improvement of strength and magnetic properties of the non-oriented electrical steel sheet.

In the first cold-rolled sheet annealing step and the second cold-rolled sheet annealing step, the cold-rolled sheet may be annealed under an atmosphere containing 40 volume % or less of hydrogen (H₂) and 60 volume % or more of nitrogen and having a dew point of 0 to −40° C. Specifically, the annealing may be performed in an atmosphere containing 5 to 40 volume % of hydrogen and 60 to 95 volume % of nitrogen. In the second cold-rolled sheet annealing process, all (i.e., 99% or more) of processed structures formed in the cold rolling step may be recrystallized.

After final annealing, an insulating film may be formed. The insulating film may be treated with organic, inorganic, and organic/inorganic composite films, and may be treated with other insulating films.

Hereinafter, the present invention will be described in more detail with reference to the following Examples. However, these Examples are only illustrative of the present invention, and the present invention is not limited thereto.

### Example 1

A slab was prepared from Table 1 and components including the remainder of Fe and inevitable impurities. The slab was heated at 1150° C. and hot-rolled at a finishing temperature of 880° C. to prepare a hot-rolled sheet having a thickness of 2.0 m. The hot-rolled sheet was subjected to the first and second hot-rolled sheet annealing at 1000° C. and 930° C. under the conditions of Table 2, respectively, and then cold-rolled to be a thickness of 0.25 mm. The cold-rolled sheet was subjected to first and second cold-rolled sheet annealing at 1000° C. and 800° C. under the conditions of Table 2, respectively.

With respect to each specimen, hot-rolled sheet annealing first and second cracking times, final annealing first and second cracking times, an average grain diameter, an area ratio of grains with a diameter of 20 n or less, YS (−40° C.), YS (210° C.), YS (210° C.)/YS (−40° C.), W10/400 iron loss, B50 magnetic flux density were summarized in Table 3.

The content of each component was measured by an ICP wet analysis method.

The average grain size and area ratio of the grains were measured by EBSD after polishing the TD cross section of the specimen so that the area was 100 mm² or more, and then the average number and area fraction values obtained when merged with a Merge function of OIM software and calculated with a Grain Size (diameter) function were used.

Tensile tests at −40° C. and 210° C. were performed according to the IS06892-2 standard. For magnetic properties such as magnetic flux density and iron loss, 60 mm wide×60 mm long×5 sheets of specimens were cut, respectively, and rolling direction and rolling vertical direction were measured with a single sheet tester, and the average values were shown. In this case, W10/400 was the iron loss when a magnetic flux density of 1.0 T was induced at a frequency of 400 Hz, and B50 meant the magnetic flux density induced in a magnetic field of 5000 A/m.

TABLE 1

| Specimen | S | Al | Mn | Sn | Sb | C | N | S | Ti | Nb | V |
|---|---|---|---|---|---|---|---|---|---|---|---|
| No. | [%] | [%] | [%] | [ppm] | [ppm] | [ppm] | [ppm] | [ppm] | [ppm] | [ppm] | [ppm] |
| A1 | 2.7 | 1.4 | 0.5 | 190 | 270 | 17 | 24 | 29 | 24 | 19 | 19 |
| A2 | 2.7 | 1.4 | 0.5 | 230 | 350 | 32 | 24 | 17 | 13 | 12 | 12 |
| A3 | 2.7 | 1.4 | 0.5 | 390 | 260 | 16 | 7 | 11 | 16 | 28 | 17 |
| A4 | 2.7 | 1.4 | 0.5 | 360 | 220 | 42 | 31 | 13 | 10 | 6 | 27 |
| B1 | 3.2 | 0.5 | 1.3 | 410 | 390 | 29 | 34 | 22 | 28 | 32 | 30 |
| B2 | 3.2 | 0.5 | 1.3 | 320 | 180 | 28 | 24 | 30 | 26 | 13 | 25 |
| B3 | 3.2 | 0.5 | 1.3 | 140 | 420 | 42 | 20 | 18 | 27 | 14 | 22 |
| B4 | 3.2 | 0.5 | 1.3 | 420 | 160 | 40 | 25 | 31 | 19 | 21 | 28 |
| C1 | 3.5 | 0.8 | 0.2 | 160 | 120 | 42 | 14 | 18 | 23 | 9 | 34 |
| C2 | 3.5 | 0.8 | 0.2 | 110 | 280 | 32 | 29 | 14 | 35 | 17 | 27 |
| C3 | 3.5 | 0.8 | 0.2 | 120 | 90 | 17 | 21 | 8 | 18 | 21 | 21 |
| C4 | 3.5 | 0.8 | 0.2 | 210 | 490 | 27 | 11 | 16 | 14 | 35 | 30 |
| D1 | 3.7 | 0.3 | 0.6 | 140 | 430 | 23 | 31 | 33 | 13 | 18 | 10 |
| D2 | 3.7 | 0.3 | 0.6 | 100 | 400 | 22 | 10 | 33 | 27 | 10 | 9 |
| D3 | 3.7 | 0.3 | 0.6 | 190 | 480 | 20 | 30 | 29 | 20 | 19 | 31 |
| D4 | 3.7 | 0.3 | 0.6 | 380 | 120 | 18 | 28 | 13 | 14 | 25 | 35 |

TABLE 2

| | Hot-rolled | | Cold-rolled | | |
|---|---|---|---|---|---|
| | sheet annealing | | sheet annealing | | |
| Specimen | cracking time | | cracking time | | Value of |
| No | First [s] | Second [s] | First [s] | Second [s] | Equation 1 |
| A1 | 65 | 30 | 61 | 20 | 1435 |
| A2 | 86 | 15 | 45 | 20 | 1775 |
| A3 | 65 | 30 | 45 | 20 | 875 |
| A4 | 55 | 45 | 40 | 20 | 200 |
| B1 | 61 | 14 | 43 | 35 | 376 |
| B2 | 61 | 35 | 43 | 10 | 858 |
| B3 | 61 | 35 | 43 | 35 | 208 |
| B4 | 48 | 40 | 39 | 40 | 8 |
| C1 | 63 | 12 | 45 | 12 | 1683 |
| C2 | 91 | 25 | 45 | 25 | 1320 |
| C3 | 63 | 25 | 45 | 25 | 760 |
| C4 | 42 | 50 | 35 | 25 | 80 |
| D1 | 65 | 30 | 42 | 8 | 1190 |
| D2 | 65 | 14 | 69 | 30 | 1989 |
| D3 | 65 | 30 | 42 | 30 | 420 |
| D4 | 39 | 55 | 31 | 30 | 16 |

TABLE 3

| | Grain | | | | | | | |
|---|---|---|---|---|---|---|---|---|
| | | ≤20 μm | Yield strength | | | | | |
| | Average | area | (YS) | | | | | |
| Specimen | diameter | ratio | −40° C. | 210° C. | YS(210° C.)/ | W10/400 | B50 | |
| No | [μm] | [%] | [MPa] | [MPa] | YS(−40° C.) | [W/kg] | [T] | Note |
| A1 | 111 | 0.16 | 441 | 305 | 0.692 | 11.5 | 1.671 | Comparative Example |
| A2 | 106 | 1.12 | 445 | 303 | 0.681 | 11.4 | 1.673 | Comparative Example |
| A3 | 78 | 1.04 | 454 | 326 | 0.718 | 11.5 | 1.673 | Invention Example |
| A4 | 75 | 1.43 | 455 | 328 | 0.721 | 11.6 | 1.672 | Invention Example |
| B1 | 81 | 0.37 | 466 | 333 | 0.715 | 12.8 | 1.673 | Comparative Example |
| B2 | 43 | 1.09 | 468 | 333 | 0.712 | 12.7 | 1.675 | Comparative Example |
| B3 | 80 | 1.23 | 464 | 338 | 0.728 | 11.4 | 1.672 | Invention Example |
| B4 | 81 | 1.07 | 467 | 339 | 0.726 | 11.3 | 1.676 | Invention Example |
| C1 | 34 | 1.21 | 505 | 360 | 0.713 | 12.9 | 1.674 | Comparative Example |
| C2 | 109 | 0.32 | 498 | 348 | 0.699 | 11.4 | 1.673 | Comparative Example |
| C3 | 66 | 0.91 | 503 | 366 | 0.728 | 11.6 | 1.675 | Invention Example |
| C4 | 62 | 1.42 | 505 | 365 | 0.723 | 11.5 | 1.674 | Invention Example |
| D1 | 36 | 0.39 | 504 | 359 | 0.712 | 12.8 | 1.674 | Comparative Example |
| D2 | 116 | 0.21 | 497 | 343 | 0.69 | 11.6 | 1.672 | Comparative Example |
| D3 | 91 | 1.24 | 508 | 365 | 0.719 | 11.6 | 1.673 | Invention Example |
| D4 | 87 | 1.12 | 506 | 367 | 0.725 | 11.4 | 1.673 | Invention Example |

As shown in Tables 1 to 3, A3, A4, B3, B4, C3, C4, D3, and D4 in which the residence times in the first and second hot-rolled sheet annealing and the first and second cold-rolled sheet annealing were properly adjusted had YS (210° C.)/YS (−40° C.) with excellent W10/400 iron loss.

On the other hand, in A1, A2, C2, and D2, the average grain diameter exceeded 100 μm or the grain area ratio of the diameter of 20 μm or less was lower than 0.5% because the first cracking time of hot-rolled sheet annealing and cold-rolled sheet annealing was out of the range, and thus the YS (210° C.)/YS (−40° C.) value was low.

In addition, in B1, B2, C1, and D1, the second cracking time of hot-rolled sheet annealing and cold-rolled sheet annealing was out of range, and the average grain diameter did not exceed 50 μm or the grain area ratio of the diameter of 20 μm or less was lower than 0.5%, and residual stress or fine precipitates were not properly controlled, so that W10/400 exhibited inferior characteristics.

The present invention can be manufactured in various different forms, not limited to the embodiments, and it will be appreciated to those skilled in the art that the present invention may be implemented in other specific forms without changing the technical idea or essential features of the present invention. Therefore, it should be appreciated that the embodiments described above are illustrative in all aspects and are not restricted.

1. A non-oriented electrical steel sheet comprising: by wt %, 2.5 to 4.0% of Si, 0.1 to 1.5% of Al, 0.1 to 1.5% of Mn, and the remainder of Fe and inevitable impurities,
wherein an average grain size is 50 to 100 μm, and an area ratio of grains having a grain size of 20 μm or less is 0.5% or more.

2. The non-oriented electrical steel sheet of claim 1, further comprising:
0.006 to 0.1 wt % of at least one of Sn and Sb.

3. The non-oriented electrical steel sheet of claim 1, further comprising:
0.005 wt % or less of at least one of C, N, S, Ti, Nb, and V.

4. The non-oriented electrical steel sheet of claim 1, further comprising:
at least one of 0.05 wt % or less of P, 0.002 wt % or less of B, 0.01 wt % or less of Mo, 0.005 wt % or less of Mg, and 0.005 wt % or less of Zr.

5. The non-oriented electrical steel sheet of claim 1, wherein
yield strengths YS (−40° C.) and YS (210° C.) obtained when tensile tests are performed at −40° C. and 210° C. satisfy YS (210° C.)/YS (−40° C.)≥0.71.

6. A method for manufacturing a non-oriented electrical steel sheet comprising:
preparing a hot-rolled sheet by hot-rolling a slab comprising, by wt %, 2.5 to 4.0% of Si, 0.1 to 1.5% of Al, 0.1 to 1.5% of Mn, and the remainder of Fe and inevitable impurities;
a first hot-rolled sheet annealing step of annealing the hot-rolled sheet at a temperature range of 950 to 1150° C. for 70 seconds or less;
a second hot-rolled sheet annealing step of annealing the hot-rolled sheet at a temperature range of 900° C. or higher and less than 950° C. for 15 seconds or more;
preparing a cold-rolled sheet by cold-rolling the hot-rolled sheet;
a first cold-rolled sheet annealing step of annealing the cold-rolled sheet at a temperature range of 900 to 1100° C. for 50 seconds or less; and
a second cold-rolled sheet annealing step of annealing the cold-rolled sheet at a temperature range of 700 to 850° C. for 15 seconds or more.

7. The method for manufacturing the non-oriented electrical steel sheet of claim 6, wherein
Equation 1 below is satisfied.
$$\vert ( {T}_{HA 1} - {T}_{HA 2} ) \times ( {T}_{CA 1} - {T}_{CA 2} ) \vert \leq 1000 \qquad [ Equation 1 ]$$
(In Equation 1, T_{HA1} represents the residence time (sec) in the first hot-rolled sheet annealing step, T_{HA2} represents the residence time (sec) in the second hot-rolled sheet annealing step, T_{CA1} represents the residence time (sec) in the first cold-rolled sheet annealing step, and T_{CA2} represents the residence time (sec) in the second cold-rolled sheet annealing step.)

8. The method for manufacturing the non-oriented electrical steel sheet of claim 6, further comprising:
heating the slab at 1200° C. or lower before the preparing of the hot-rolled sheet.

9. The method for manufacturing the non-oriented electrical steel sheet of claim 6, wherein
the preparing of the hot-rolled sheet comprises finish rolling at 800° C. or higher.

10. The method for manufacturing the non-oriented electrical steel sheet of claim 6, wherein
the first cold-rolled sheet annealing step and the second cold-rolled sheet annealing step are performed under an atmosphere containing 40 volume % or less of hydrogen (H₂) and 60 volume % or more of nitrogen and having a dew point of 0 to −40° C.
